(19) United States
(12) Patent Application Publication
(10) Pub. No.: US 2026/0276014 A1
(43) Pub. Date: Sep. 17, 2026

(54) FASTENING ASSEMBLY FOR SCREW-FREE AND THEFT-PROOF FASTENING OF AN EXTERNAL ATTACHMENT TO A MOTOR VEHICLE

(71) Applicant: AUDI AG, Ingolstadt (DE)

(72) Inventors: Philipp ENGELMANN, Zwickau (DE); Pascal BERDEL, Altmannstein (DE); Jekaterina BYCKOV, Bad Friedrichshall (DE); Rupert LINTL, Altmannstein (DE); Sebastian SCHEIBNER, Ingolstadt (DE)

(73) Assignee: AUDI AG, Ingolstadt (DE)

(21) Appl. No.: 19/436,730

(22) Filed: Dec. 30, 2025

(30) Foreign Application Priority Data
Mar. 12, 2025 (DE) 102025109377.6

(51) Int. Cl. F16B 5/06; B60R 13/04

(52) U.S. Cl. CPC F16B 5/06; B60R 13/04

(57) ABSTRACT

A fastening assembly for screw-free and theft-proof fastening of an external attachment to a motor vehicle. The external attachment includes multiple fixing elements which are intended to engage behind an opening edge of a fastening opening formed on the motor vehicle. The external attachment can be fastened from the outside by placing it on the fastening opening. The fixing elements engage in the fastening opening, and then displacing it, so the fixing elements engage behind the opening edge. The external attachment includes a locking element that prevents the fastened external attachment from being pushed back and is only unlockable from the inside.

### FIELD

The invention relates to a fastening assembly for the screw-free and theft-proof fastening of an external attachment to a motor vehicle according to the preamble of claim 1. The invention furthermore relates to a motor vehicle having at least one correspondingly fastened external attachment.

### BACKGROUND

An external attachment is an exterior component that is fastened to the outside of a motor vehicle, in particular to the vehicle body. Such an external attachment is, for example, a camera module or camera mount, a lighting module, a sensor module or sensor mount, a logo or design element, etc.

An installation assembly for an external attachment of a motor vehicle is known from DE 20 2017 104 834 U1. After installation, it is no longer possible to remove the external attachment nondestructively, which secures the external attachment against theft.

The fastening assembly according to the invention of claim 1 enables easily handled installation of the external attachment and also enables non-destructive removal of the external attachment while simultaneously providing theft protection. The other independent claim also extends the invention to a motor vehicle comprising at least one external attachment that is correspondingly fastened, i.e. fastened using the fastening assembly according to the invention.

Advantageous refinements and embodiments of the invention result analogously for both subjects of the invention from the dependent claims, the following description of the invention (this expressly includes optional and exemplary features), and the figures.

The external attachment of the fastening assembly according to the invention comprises (i.e. at least two) fixing elements which are intended and designed accordingly to engage behind an opening edge of a fastening opening formed on the motor vehicle.

### SUMMARY

According to the invention, the external attachment and the (vehicle-side) fastening opening are designed such that the external attachment is fastenable from the outside or externally (at the fastening point) by placing it on the fastening opening, wherein the fixing elements engage in the fastening opening, and subsequently displacing it, wherein the fixing elements engage behind the opening edge of the fastening opening. Displacing refers in particular to an essentially translational sliding movement of the external attachment parallel to the plane of the fastening opening. Furthermore, the external attachment has a locking element that prevents the fastened external attachment from being pushed back and that is only unlockable or can only be unlocked from the inside or the interior.

The external attachment is preferably fastened only by means of the fixing elements, which engage behind the opening edge, by which a form-fitting rear engagement is meant in particular. Preferably, the fixing elements are formed hooked. There are at least two fixing elements, preferably at least three fixing elements, present, which fix or secure the external attachment in a multidirectional manner. In particular, additional screwing and/or adhesive bonding is not provided. Multiple fastening openings can be provided for fastening the external attachment, with the same effect. The external attachment can also comprise multiple locking elements, wherein a single locking element is preferred. The external attachment can be fastened or installed manually, i.e. without tools. The same applies to releasing or removing the external attachment.

According to the invention, at least one locking element located on the external attachment is present, which prevents the fastened external attachment from being pushed back, i.e. after the displacement the external attachment in the intended fastening position, so that it is not easily possible to release or remove the external attachment without damage and thus theft protection is implemented. The locking element can only be unlocked from the inside, i.e. from the back side, in particular unlocked manually, whereupon the external attachment can be pushed back against the fastening sliding movement and thus released again nondestructively. This requires access to the inside or back side at the fastening point, which is in particular only possible after extensive disassembly work (for example, removal of trim parts of the motor vehicle) is provided. In particular, no predetermined breaking points or the like are provided on the external attachment to allow it to be removed or disassembled. The locking element is preferably designed and arranged in such a way that the fastening or installation of the external attachment is easily possible.

Preferably, the locking element is designed and arranged in such a way that it locks against the opening edge of the fastening opening when the external attachment (after the displacement) is in the fastening position, and thus prevents the external attachment from being pushed back. The locking element can be designed as a spring-loaded detent element or the like, which springs back when the external attachment is fastened or displaced, namely as soon as the external attachment is in the intended fastening position, in particular without engaging behind the opening edge, and which then locks against the opening edge of the fastening opening to prevent the external attachment from being pushed back.

Preferably, the locking or detent element is designed in such a way that the springing back is perceptible in a tactile and/or acoustic manner, so that the correct fastening of the external attachment can be indicated during fastening or installation via this.

After fastening or installing the external attachment, the lock can be released by pushing back or pressing in the locking or detent element, which is only possible from the inside or from the back side, and the external attachment can then be pushed back and released or removed.

The fixing elements and the locking element are components, in particular integrated components, of the external attachment. Preferably, the external attachment is formed in one piece, i.e. including the fixing elements and the locking element, from plastic, in particular from thermoplastic plastic. Preferably, it is a plastic injection-molded part. The external attachment can therefore also be described as a plastic attachment.

The external attachment can comprise a flange surrounding the fastening opening, using which the external attachment is supported be supportable around the fastening opening. A seal can be arranged on the flange. In particular, it is an adhesively-bonded or injection-molded seal, preferably made of a soft or elastic plastic material. The seal is intended to seal the fastening opening. Furthermore, the seal can also function as tolerance compensation and as scratch protection.

The invention also extends to a motor vehicle that comprises at least one correspondingly fastened external attachment. The external attachment is fastened in particular to the vehicle body, for which purpose a corresponding fastening opening is formed in the outer body skin, which is in particular a punched hole. The fastening opening or punched hole can already be created during vehicle production and then used to fasten or install the relevant external attachment, wherein the invention is also suitable for retrofitting. To unlock the locking element, internal or rear access is required at the fastening point, which is in particular only provided after removing trim parts of the vehicle.

In summary, the invention is accompanied by the following advantages (this is not an exhaustive list):
Reduction of cost and time expenditures for the fastening or installation of the external attachment.
The external attachment can be installed and removed without tools (although the use of a tool can also be provided).
Prevention of paint and corrosion damage to the motor vehicle, in particular to the vehicle component on which the external attachment is fastened.
Reduction in the number of parts and components by eliminating separate fixing and/or fastening elements.
Implementation of new installation space utilization concepts, since on the one hand no clearances for tools as well as fixing and/or fastening elements are required and on the other hand the installation of the external attachment can only be carried out from the outside or externally (facilitated assembly accessibility), wherein the installation time is flexibly selectable.
No predetermined breaking points or the like are required.
The external attachment is removable nondestructively and reusable.

Within the scope of the invention, both the features described above and those explained hereinafter are applicable not only in the respective combination of features specified, but also in other combinations of features or on their own. This also applies to the features shown in the figures.

### BRIEF DESCRIPTION OF THE FIGURES

The invention is explained in more detail hereinafter non-restrictively on the basis of an exemplary embodiment shown in the figures. The features shown in the figures and/or the features explained hereinafter can be general features of the invention, even independently of specific combinations of features, and can refine the invention accordingly.

FIG. 1 shows a fender of a motor vehicle having an external attachment fastened thereon.

FIG. 2 shows the inside or back side of the fastening point when fastening the external attachment to the fender of FIG. 1.

FIG. 3 shows, analogously to FIG. 2, the fastening point, wherein the external attachment is in the intended fastening position.

### DETAILED DESCRIPTION

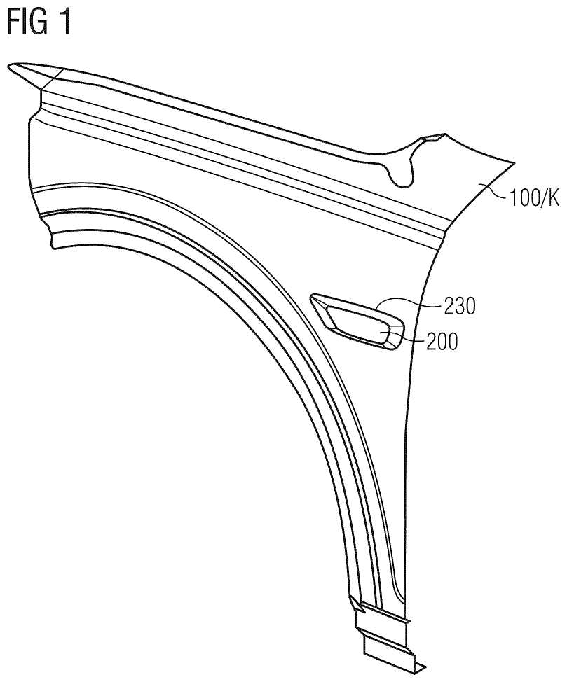

An external attachment 200 is fastened to the outside of the fender 100 shown in FIG. 1 of a motor vehicle K (not shown further). The external attachment 200 can be a lighting module (such as a side turn signal) or a camera module or also a support part (bracket) provided for this purpose. The fender 100 can be made of sheet metal or plastic.

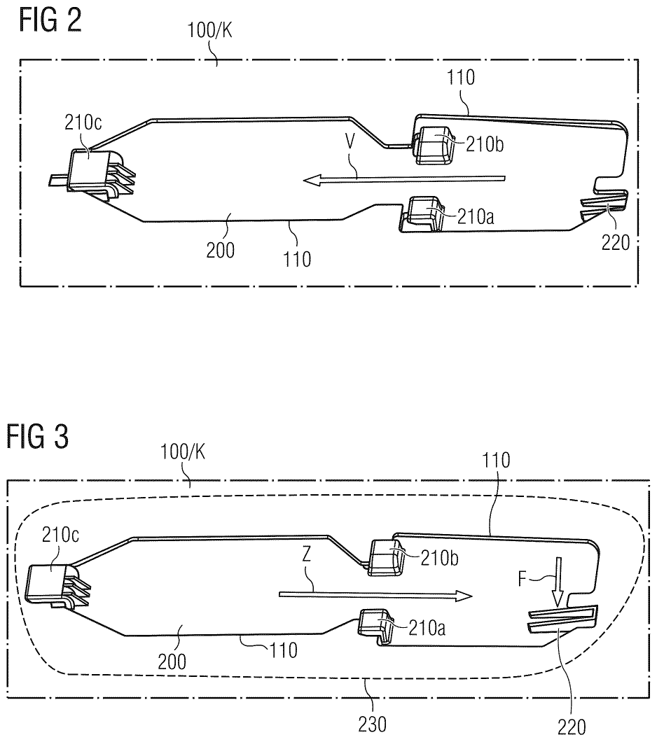

FIG. 2 and FIG. 3 show the fastening point of the external attachment 200 from the inside or rear, i.e. looking at the back side of the fender 100. The fender 100 comprises a fastening opening 110 having complex hole geometry at the fastening point. The external attachment 200 comprises multiple hooked fixing elements 210a, 210b, 210c, which are each intended to engage behind a corresponding opening edge section of the fastening opening 110 in a form-fitting manner, as shown in FIG. 3, by which the external attachment 200 is fastened to the fender 100.

To fastened the external mounting part 200, it is placed on the fender 100 from the outside or exterior at the fastening point, so that the fixing elements 210a, 210b, 210c engage in the fastening opening 110, as shown in FIG. 2. Upon subsequent displacement of the external attachment 200 relative to the fender 100 (and relative to the fastening opening 110), the external attachment 200 reaches the intended fastening position (end position), in which the fixing elements 210a, 210b, 210c engage behind the opening edge of the fastening opening 110 (hooking behind), as shown in FIG. 3. The displacement occurs quasi-parallel to the plane of the fastening opening 110 in a predetermined direction and is illustrated in FIG. 2 by the arrow V (sliding movement).

The external attachment 200 also comprises a locking element 220 that prevents the fastened external attachment 200 from being pushed back from the fastening position shown in FIG. 3. The locking element 220 is designed as a spring-loaded detent element, more precisely as a locking bolt having spring action, which is pressed in and pre-tensioned when the external attachment 200 is placed on the fender 100 and then snaps back or springs back when the external attachment 200 is displaced V, as soon as the external attachment 200 is in the intended fastening position (end position). This can be clearly seen in FIG. 2 and FIG. 3. The locking element 220 which has sprung back locks or blocks against the opening edge of the fastening opening 110 without engaging behind it and thus prevents the external attachment 200 from being pushed back against the fastening sliding movement V. Displacement of the external attachment 200 in other directions is prevented by the fixing elements 210a, 210b, 210c.

By pushing back or pressing in the spring-loaded locking element 220, as illustrated by arrow F in FIG. 3, the lock can be released and then the external attachment part 200 can be pushed back and thus released or removed, as illustrated by arrow Z in FIG. 3. The locking detent 220 is not unlockable from the outside, but only from the inside or from the back. For this purpose, the wheel located in the wheel arch of the motor vehicle K and the wheel arch shell have to be removed. The pushing-back or pushing-in action F of the spring-loaded detent element 220 can be done manually by means of finger operation or also by means of a tool (such as a screwdriver). Furthermore, the spring-loaded detent element 220 can also be designed differently.

The external attachment 200 comprises a flange 230, indicated by dashed lines in FIG. 3, using which the external attachment 200 is supported flatly around the fastening opening 110 on the outside of the fender 100 (see also FIG. 1). A seal can be arranged on the flange 230.

Further features and possible embodiments of the invention are described above.

1. A fastening assembly for screw-free and theft-proof fastening of an external attachment to a motor vehicle, wherein the external attachment comprises multiple fixing elements which are intended to engage behind an opening edge of a fastening opening formed on the motor vehicle,
wherein the external attachment can be fastened from the outside by placing it on the fastening opening, wherein the fixing elements engage in the fastening opening, and then displacing it, wherein the fixing elements engage behind the opening edge, and that the external attachment comprises a locking element that prevents the fastened external attachment from being pushed back and is only unlockable from the inside.

2. The fastening assembly according to claim 1, wherein the locking element is designed in such a way that it locks against the opening edge of the fastening opening and in this way prevents the external attachment from being pushed back.

3. The fastening assembly according to claim 2, wherein the locking element is designed as a spring-loaded detent element, which springs back upon the displacement of the external attachment and then locks against the opening edge of the fastening opening.

4. The fastening assembly according to claim 3, wherein the springing back of the locking element is perceptible in a tactile and/or acoustic manner.

5. The fastening assembly according to claim 1, wherein the external attachment comprises at least three fixing elements.

6. The fastening assembly according to claim 1, wherein the external attachment is formed in one piece from plastic.

7. The fastening assembly according to claim 1, wherein the external attachment comprises a flange surrounding the fastening opening.

8. The fastening assembly according to claim 7, wherein a seal is arranged on the flange.

9. A motor vehicle having at least one external attachment which is fastened according to claim 1.

10. The motor vehicle according to claim 9, wherein the external attachment is fastened to the vehicle body and a fastening opening is formed in the outer body skin for this purpose.

11. The fastening assembly according to claim 2, wherein the external attachment comprises at least three fixing elements.

12. The fastening assembly according to claim 3, wherein the external attachment comprises at least three fixing elements.

13. The fastening assembly according to claim 4, wherein the external attachment comprises at least three fixing elements.

14. The fastening assembly according to claim 2, wherein the external attachment is formed in one piece from plastic.

15. The fastening assembly according to claim 3, wherein the external attachment is formed in one piece from plastic.

16. The fastening assembly according to claim 4, wherein the external attachment is formed in one piece from plastic.

17. The fastening assembly according to claim 5, wherein the external attachment is formed in one piece from plastic.

18. The fastening assembly according to claim 2, wherein the external attachment comprises a flange surrounding the fastening opening.

19. The fastening assembly according to claim 3, wherein the external attachment comprises a flange surrounding the fastening opening.

20. The fastening assembly according to claim 4, wherein the external attachment comprises a flange surrounding the fastening opening.
